(19) United States
(12) Patent Application Publication
(10) Pub. No.: US 2006/0011869 A1
(43) Pub. Date: Jan. 19, 2006

(54) Measurement method of electron beam current, electron beam lithography method and system

(76) Inventors: Noriyuki Tanaka, Hitachinaka (JP); Ken Iizumi, Hitachinaka (JP); Yoshinori Nakayama, Sayama (JP); Hiroya Ohta, Kodaira (JP); Makoto Sakakibara, Kokubunji (JP); Yasuhiro Someda, Utsunomiya (JP)

Correspondence Address: DICKSTEIN SHAPIRO MORIN & OSHINSKY LLP, 2101 L Street, NW, Washington, DC, 20037, US

(21) Appl. No.: 11/180,629

(22) Filed: Jul. 14, 2005

(30) Foreign Application Priority Data
Jul. 15, 2004 (JP) 2004-208671

(51) Int. Cl. G21G 5/00; G21K 5/10

(52) U.S. Cl. 250/492.22; 250/492.1

(57) ABSTRACT

In an electron-beam lithography system for performing a pattern drawing by causing electron beams to be switched ON/OFF at a high speed in an exposure/non-exposure portion, non-straight line property of beam shot dosage relative to beam ON time worsens dimension accuracy of the drawing pattern formed on a sample. In order to avoid this drawback, the characteristic of the beam shot dosage relative to the beam ON time is measured in advance, thereby creating correction data for the beam ON time beforehand. Then, at the time of performing the pattern drawing, the beam ON time is corrected based on the correction data so that desired beam shot dosage becomes acquirable.

### BACKGROUND OF THE INVENTION

1. Field of the Invention

The present invention relates to an electron-beam lithography method and system for performing a pattern drawing by using an electron beam, and an electron-beam current measurement method.

2. Description of the Related Art

In recent years, in electron-beam lithography systems used for fabricating semiconductor integrated circuits, significant progress has been made in miniaturization of elements within a semiconductor integrated circuit, complication of circuit pattern, and implementation of large-capacity pattern data. This situation has caused requests for an enhancement in drawing throughput as well as an enhancement in drawing accuracy. On account of this, in addition to an electron-beam lithography system according to the variable shaped beam scheme employed from conventionally, an electron-beam lithography system according to the cell projection exposure scheme has been being developed. In this cell projection exposure scheme, repeated patterns are formed on an aperture for shaping the electron beam, thereby performing exposure at one time.

A tremendous increase, however, has occurred in the requested accuracy for the semiconductor lithography systems. Namely, in accompaniment with miniaturization of circuit pattern and implementation of large-diameter wafer, requests are now being made for implementation of even higher accuracy and even higher speed. In trying to respond to these requests, in recent years, developments of an EPL (Electron Projection Lithography) and an electron-beam lithography system according to the multi-electron-beam scheme have been vigorously promoted as next-generation lithography systems. In this multi-electron-beam scheme, a plurality of electron beams are deflected at the same time, and then the electron beams are switched ON/OFF in an exposure/non-exposure portion of the wafer, thereby performing a pattern drawing.

As compared with the conventional electron-beam lithography systems, these next-generation electron-beam lithography systems exceedingly differ therefrom in their drawing schemes. This difference results in occurrences of new technological problems.

In the electron-beam current measurement which becomes the criterion for determining electron-beam shot dosage at the time of a pattern drawing, as disclosed in, e.g., U.S. Pat. No. 5,932,884, the following method is employed: Namely, an ammeter is connected to a Faraday cup, and then the electron beam is irradiated thereon, thereby determining the current value or the current density based thereon.

In particular, the electron-beam lithography system according to the multi-electron-beam scheme is based on the drawing scheme of controlling the beam shot dosage by causing the electron beams of feeble currents to be switched ON/OFF at a high speed. Determining and controlling the beam shot dosage makes it absolutely necessary to utilize high-accuracy beam measurement technologies. From the viewpoint of signal-to-noise ratio, however, it is difficult to measure the feeble-current and high-speed pulse-shaped beam currents with an excellent accuracy by using the ordinary Faraday cup and ammeter. In contrast thereto, a method is effective which integrates the beam currents by integrating outputs of an electron-beam detection member by using an integration circuit. Here, letting the beam current be i and the beam shot time be t, the beam shot dosage Q is defined as the following expression (1):

$$Q = {\int }_{0}^{t} i \cdot ⅆ t \qquad Expression 1$$

At this time, the relationship expression between the beam shot dosage Q and output voltage Vout of the integration circuit can be determined as follows:

$$Vout = \frac{N \cdot Q}{C} = \frac{N}{C} {\int }_{0}^{t} i \cdot ⅆ t \qquad Expression 2$$

Here, notation C denotes capacity of the integration circuit, and notation N denotes pulse number. Assuming that the beam current i remains constant when the electron beam is in the ON state, the beam shot dosage Q can be represented by the product of the beam current i and the exposure time t. As a result, the beam shot dosage Q is represented by a straight line as is illustrated in FIG. 2(a). Making the actual measurement at this time, however, results in a non-straight line as is illustrated in, e.g., FIG. 2(b).

Hereinafter, referring to FIG. 3A to FIG. 3D, the explanation will be given below concerning one of the causes which are attributed to the above-described inconsistency. FIG. 3A and FIG. 3B illustrate examples of the position relationships between an electron beam 102 and a blanking-aperture opening portion 301 in the beam ON state and the beam OFF state. FIG. 3A illustrates the beam OFF state. In this state, a blanking electrode 105b is grounded, and a voltage is applied to a blanking electrode 105a. This applied voltage changes orbit of the electron beam 102, thereby preventing the electron beam 102 from passing through the blanking-aperture opening portion 301.

Meanwhile, FIG. 3B illustrates the case where no voltage (i.e., zero volt) is applied to the blanking electrode 105a. At this time, the electron beam 102 is transitioned into the beam ON state. Also, FIG. 3C and FIG. 3D are schematic diagrams for illustrating the relationship between the blanking voltage in the states illustrated in FIG. 3A and FIG. 3B and the beam current which has passed through the blanking aperture. As illustrated in FIG. 3C, a constant period of time is needed until the blanking voltage has risen (or has fallen). As a result, as illustrated in FIG. 3D, a constant period of rising (or falling) time appears in the beam current as well. On account of this, if the beam ON time is gradually shortened from waveforms indicated by solid lines in FIG. 3C and FIG. 3D, as indicated by dashed lines in FIG. 3C and FIG. 3D, the electron beam 102 is transitioned into the beam OFF state before the electron beam has passed through the blanking aperture completely. This decreases absolute value of the beam current.

As a consequence, as illustrated in FIG. 2(b), the actually-measured beam shot dosage is decreased as compared with the ideal value (i.e., the value on FIG. 2(a)). In addition to the above-described factor, as the factors which will exert influences on the non-straight line property of the beam shot dosage relative to the beam ON time, there can be mentioned such factors as defocus of the beam, beam shape, and deviation of the beam axis.

In this way, the non-straight line property of the beam shot dosage relative to the beam ON time, which is brought about by the various causes, results in a lack or excess of the beam shot dosage irradiated on a sample. As a consequence, there exists a problem of worsening the dimension accuracy of a drawing pattern formed on the sample.

### SUMMARY OF THE INVENTION

In view of the problem like this, an object of the present invention is to provide an electron-beam lithography method and its system which make it possible to form a high-dimension-accuracy drawing pattern on a sample.

Also, in the multi-electron-beam lithography system for performing a pattern drawing by using a plurality of electron beams, characteristics of each electron beam, such as beam current and blanking characteristics, differ on each electron-beam basis. Accordingly, even if one and the same beam ON time is set to each electron beam, the beam shot dosage becomes different for each electron beam (This is due to causes such as nonuniformity in radiation angle distribution of an electron source, and mechanical manufacture errors in apertures, lenses, and a projection optical system). As a consequence, there exists a problem of worsening the dimension accuracy of a drawing pattern formed on a sample.

In view of the problem like this, an object of the present invention is to provide a multi-electron-beam lithography method and its system which make it possible to form a high-dimension-accuracy drawing pattern on a sample.

The present invention is configured as follows: Namely, in the electron-beam lithography system for performing a pattern drawing by causing the electron beams to be switched ON/OFF at a high speed, the characteristic of the beam shot dosage relative to the beam ON time is measured in advance. Next, correction data for the beam ON time is created from the characteristic measured. Moreover, correction for the beam ON time is performed based on the correction data created.

According to the present invention, it becomes possible to provide the electron-beam lithography method and electron-beam lithography system which allow formation of a high-dimension-accuracy drawing pattern on a sample.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for illustrating an embodiment of the present invention;

FIG. 2 is the diagram for illustrating the example of the characteristic of the beam shot dosage relative to the electron-beam ON time;

FIG. 3A to FIG. 3D are the diagrams for illustrating the position relationships between the electron beam and the blanking-aperture opening portion in the electron-beam ON/OFF state, and the schematic diagrams for illustrating the blanking voltage and the beam-current waveform;

FIG. 4 is a flowchart for illustrating measurement steps of measuring the beam shot dosage;

FIG. 5 is a flowchart for illustrating creation steps of creating correction data for the beam ON time;

FIG. 6, which relates to another embodiment of the present invention, is a schematic diagram for illustrating the electron-beam lithography system according to the multi-electron-beam scheme;

FIG. 7A and FIG. 7B are schematic diagrams for illustrating a single-electron-beam detection member and a multi-electron-beam detection member;

FIG. 8, which relates to still another embodiment of the present invention, is a schematic diagram for illustrating an electron-beam lithography system where there are provided measurement systems for offset measurement; and

FIG. 9, which relates to an even further embodiment of the present invention, is a schematic diagram for illustrating an electron-beam lithography system where there is provided a measurement system which becomes criterion at the time of measuring gain of an electron-beam detection member having amplification function.

### DETAILED DESCRIPTION OF THE INVENTION

Hereinafter, in the sequence starting from a first embodiment, the explanation will be given below concerning embodiments according to modes of the present invention.

### Embodiment 1

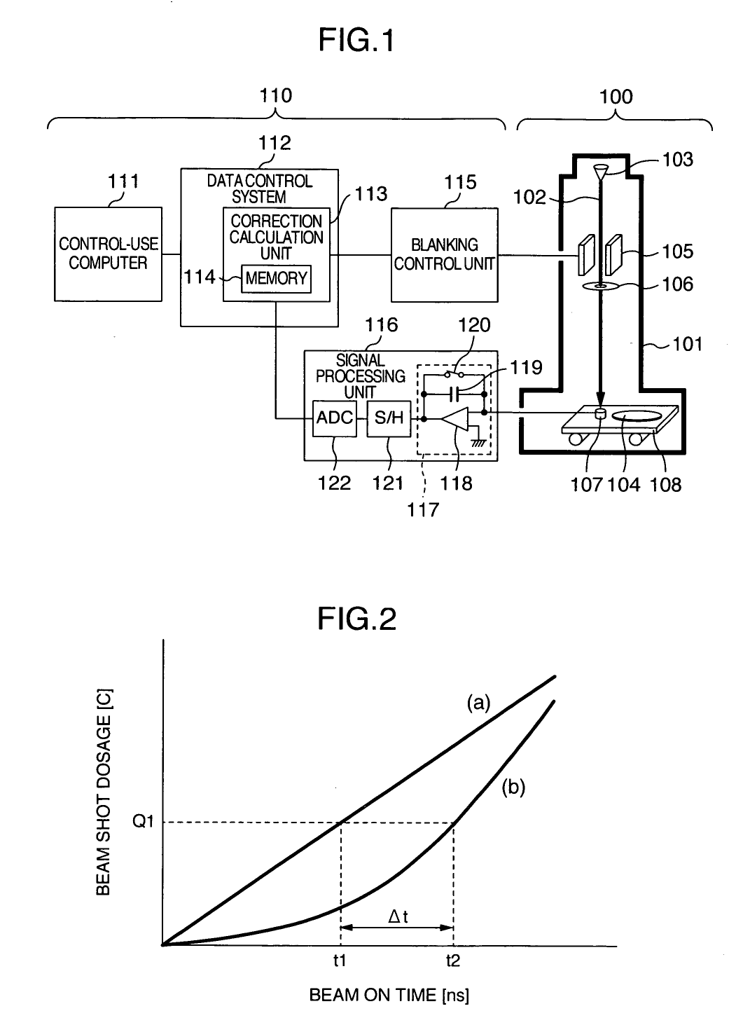

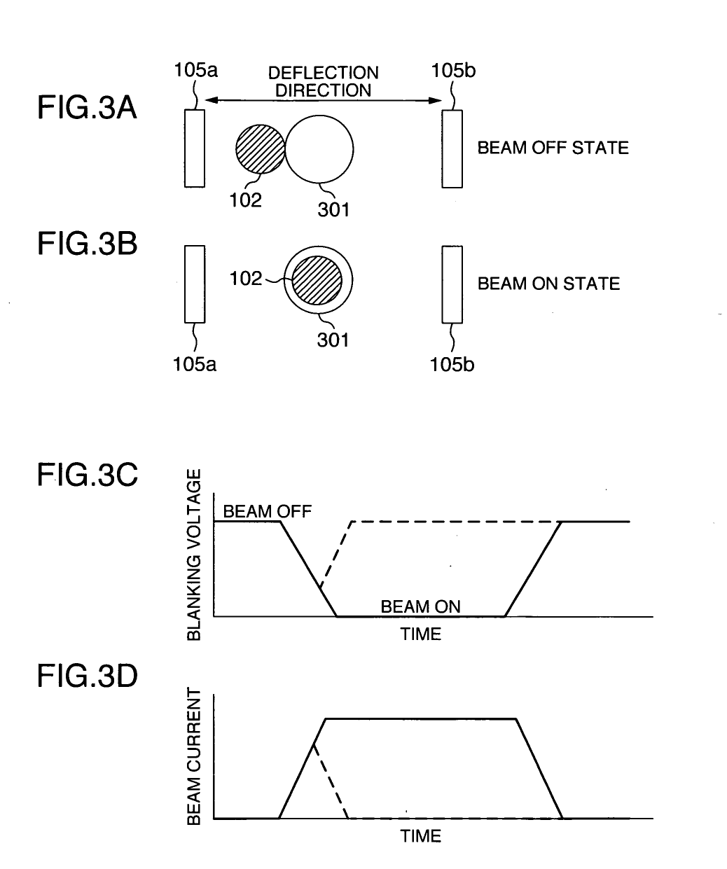

Hereinafter, referring to FIG. 1, the explanation will be given below regarding an embodiment of the present invention. As the embodiment, the case will be selected where the present invention is applied to an electron-beam lithography system.

An electron optical system 100 includes the following configuration components: A column 101 the inside of which is vacuum, an electron gun 103 for generating an electron beam 102, a blanking electrode 105 for performing ON/OFF of the electron beam 102 to be irradiated onto a sample 104, a blanking aperture 106 for preventing the blanked electron beam 102 from being irradiated onto the sample 104, an electron-beam detection member 107 for detecting the electron beam 102, and a stage 108 for mounting thereon the sample 104 and the electron-beam detection member 107.

Also, in the drawing, a control system 110 includes the following configuration components: A control-use computer 111 for performing integrated management of the control system as a whole, a data control system 112 for performing various types of data processings, a blanking control unit 115, and a signal processing unit 116.

The characteristic of the electron-beam lithography system in the present embodiment is that a correction calculation unit 113 is newly provided in the data control system 112. This correction calculation unit 113 has a function of creating correction data for beam ON time on the basis of measurement data on beam shot dosage relative to each-beam ON time sent from the signal processing unit 116. Moreover, the correction data is memorized into each address of a memory 114.

Also, the correction calculation unit 113 has a function of correcting the beam ON time at the time of a pattern drawing by reading the in-advance created correction data from the memory 114 with respect to data which describes the beam ON time within drawing pattern data. Namely, the correction calculation unit 113 includes a correction calculation member for performing the correction calculation of the beam shot time.

Incidentally, in the present invention, the explanation will be omitted regarding the data processings performed by the units other than the correction calculation unit 113 in the data control system 112.

The blanking control unit 115 generates a pulse-shaped blanking voltage to be applied to the blanking electrode 105 in correspondence with data sent from the data control system 112, such as pulse width, pulse number, and amplitude. The signal processing unit 116 includes an integration circuit 117 for integrating output signal of the electron-beam detection member 107, a sample/hold circuit (S/H) 121 for performing sampling of output voltage of the integration circuit 117, and an A/D converter 122 (ADC: Analogue-to-Digital Converter) for converting the analogue signal subjected to the sampling into a digital signal.

Here, measurement method of measuring the beam shot dosage in the present embodiment is the general method, i.e., the scheme of integrating the pulse-shaped beam current by the amount of N pulses, and determining shot dosage of the per-pulse electron beam from the integration value of the N pulses. This is because it is difficult to directly measure the shot dosage of the electron beam which repeats the switching of ON/OFF. For this integration, the integration circuit 117 is used where a return capacitor (integration capacitor 119) is connected to an operational amplifier 118.

Hereinafter, the explanation will be given below in the sequence of steps of measuring the beam shot dosage, steps of creating the correction data for the beam ON time, and operation of the correction calculation unit 113 at the time of a pattern drawing.

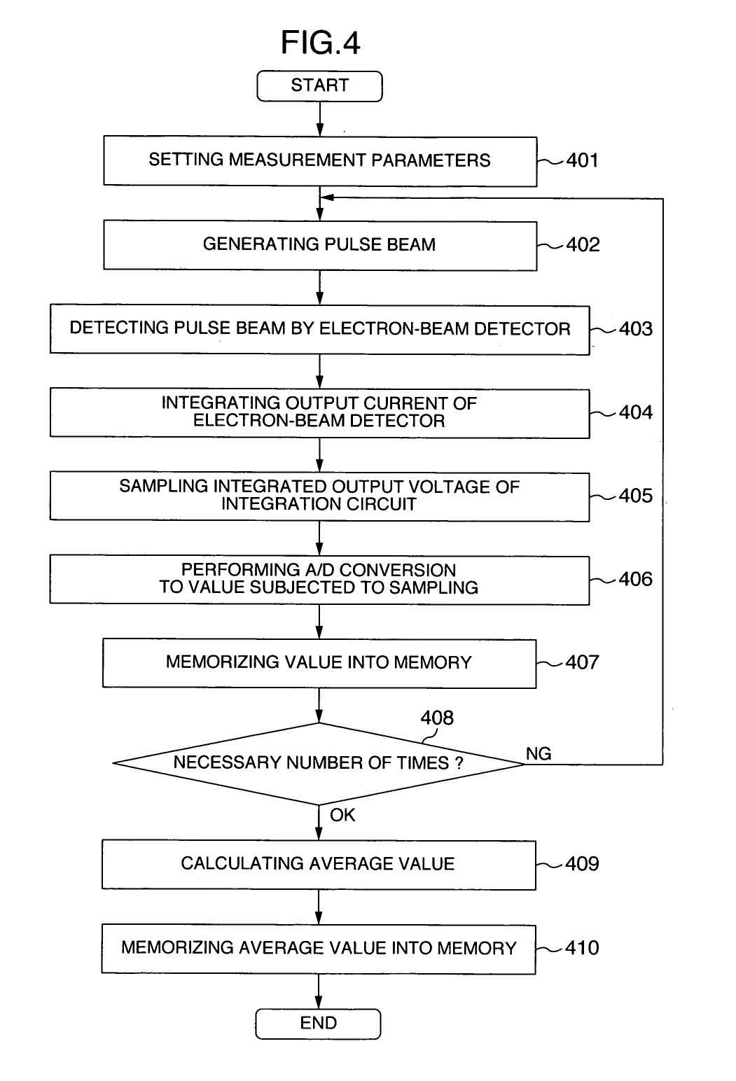

First, referring to FIG. 4, the detailed explanation will be given below concerning the steps of measuring the beam shot dosage. Here, as designations other than the steps, the ones in FIG. 1 will be used. Up until starting of the measurement, a switch 120 which is connected to the integration capacitor 119 in parallel therewith is in the ON state (the integration capacitor 119 is reset).

A step 401 indicates the following operation: Activation is started from the control-use computer 111, then transferring, to the data control system 112, drawing pattern data for measuring the beam shot dosage.

A step 402 indicates the following operation: The drawing pattern data, which is converted into beam ON times and pulse number in the data control system 112, is transferred to the blanking control unit 115. Next, the blanking control unit 115 outputs a pulse voltage corresponding to the data converted. Moreover, the unit 115 applies the pulse voltage to the blanking electrode 105, thereby generating a pulse beam.

A step 403 indicates the following operation: The pulse beam generated is irradiated onto the electron-beam detection member 107. Next, the electron-beam detection member 107 outputs a current which is proportional to the beam-current quantity entering the detection member.

A step 404 indicates the following operation: Simultaneously with the generation of the pulse beam, the switch 120 is transitioned into the OFF state. As a result, the integration circuit 117 starts integration of the beam current.

A step 405 indicates the following operation: After the blanking control unit 115 has outputted the pulse voltage by the amount of pulses in constant number, the sample/hold circuit 121 located at the backward stage of the integration circuit 117 performs sampling of the integrated output voltage.

A step 406 indicates the following operation: The A/D converter 122 located at the backward stage of the sample/hold circuit 121 converts the integrated output voltage subjected to the sampling from the analogue quantity into digital quantity.

A step 407 indicates the following operation: The measurement value converted into the digital quantity is memorized into the memory 114.

A step 408 indicates the following operation: It is judged whether or not the steps 402 to 406 have been repeated in necessary number of times. As the necessary number of times, number of times satisfying a predetermined necessary measurement accuracy will be set.

A step 409 indicates the following operation: The correction calculation unit 113 calculates average value of the values acquired by the repeated measurements.

A step 410 indicates the following operation: The average value calculated at the step 409 is memorized into the memory 114.

In FIG. 4, the measurement operations have been repeated in the plurality of times in order to reduce a variation in the measurement value caused by factors such as noise. If, however, the desired measurement accuracy has been satisfied, only one time of measurement is satisfying enough.

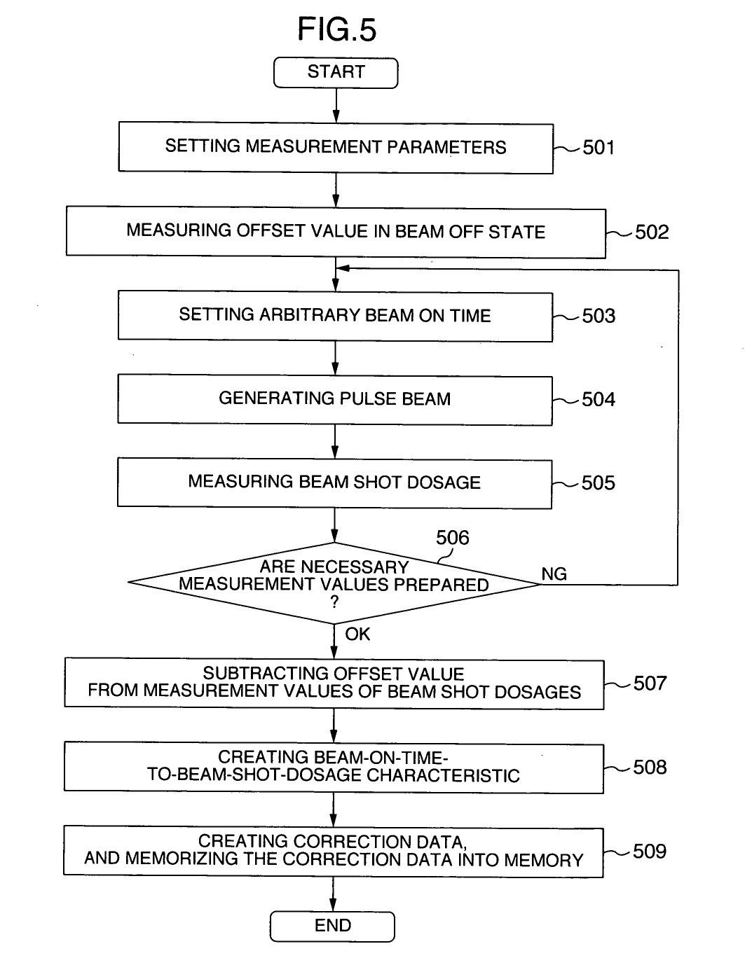

Next, referring to FIG. 5, the detailed explanation will be given below regarding the steps of actually creating the correction data for the beam ON time. Here, as designations other than the steps, the ones in FIG. 1 will be used.

A step 501 indicates the following operation: From the control-use computer 111, the measurement parameters for measuring the beam shot dosage are set to the data control system 112. The measurement parameters are ones such as the pulse number and the plurality of pulse widths (beam ON times).

A step 502 indicates the following operation: In the beam OFF state, the measurement operations of measuring the beam shot dosage are performed in accordance with the steps illustrated in FIG. 4. This is because, even if the measurement has been performed in the beam OFF state, the measurement value is not equal to zero, but becomes equal to a certain amount of value (i.e. offset value).

A step 503 indicates the following operation: In accordance with the measurement parameters set at the step 501, one beam ON time is set.

A step 504 indicates the following operation: The blanking control unit 115 outputs the pulse voltage corresponding to the beam ON time set at the step 503. Moreover, the unit 115 applies the pulse voltage to the blanking electrode 105, thereby generating the pulse beam.

A step 505 indicates the following operation: The integration value of the beam current (i.e., the beam shot dosage) is measured in accordance with the steps illustrated in FIG. 4.

A step 506 indicates the following operation: In accordance with the measurement parameters set at the step 501, it is judged whether or not the measurements of all the beam shot dosages have been completed for the plurality of beam ON times.

A step 507 indicates the following operation: The correction calculation unit 113 reads the measurement values from the memory 114, then subtracting in a software way the offset value from the measurement values during the respective beam ON times.

A step 508 indicates the following operation: The correction calculation unit 113 performs conversion from the measurement value to the beam shot dosage, thereby determining the beam-ON-time-to-beam-shot-dosage characteristic as is illustrated in FIG. 2. The relationship between the output voltage of the integration circuit and the beam shot dosage is exactly the one indicated in the Expression 2.

A step 509 further indicates the following operation: The correction quantity for the beam ON time with respect to a desired beam shot dosage is determined from this characteristic. Concretely, this operation step is as follows: For example, assuming that the characteristic as is illustrated in FIG. 2(b) has been acquired, in the case of the beam shot dosage Q1, the difference Δt between the ideal value t1 of the beam ON time and the measurement value t2 thereof illustrated in FIG. 2(b), or correction constant α (=t2/t1) will be calculated. This calculation is executed in the correction calculation unit 113 in FIG. 1, then being memorized into the memory 114 within the correction calculation unit.

Next, referring to FIG. 1, the explanation will be given below concerning the operation of the correction calculation unit 113 at the time of a pattern drawing operation.

At first, if the drawing pattern data has been sent to the correction calculation unit 113, the unit 113 makes the correction for the beam ON time data within the drawing pattern data. The unit 113 makes this correction by adding, to the beam ON time data, the correction quantity Δt memorized in the memory 114 within the correction calculation unit, or by multiplying the beam ON time data by the correction constant α. After that, the correction calculation unit 113 transfers the corrected data to the blanking control unit 115, thereby causing the unit 115 to generate a pulse during the beam ON time corresponding to the corrected data. This allows formation of a high-accuracy drawing pattern.

### Embodiment 2

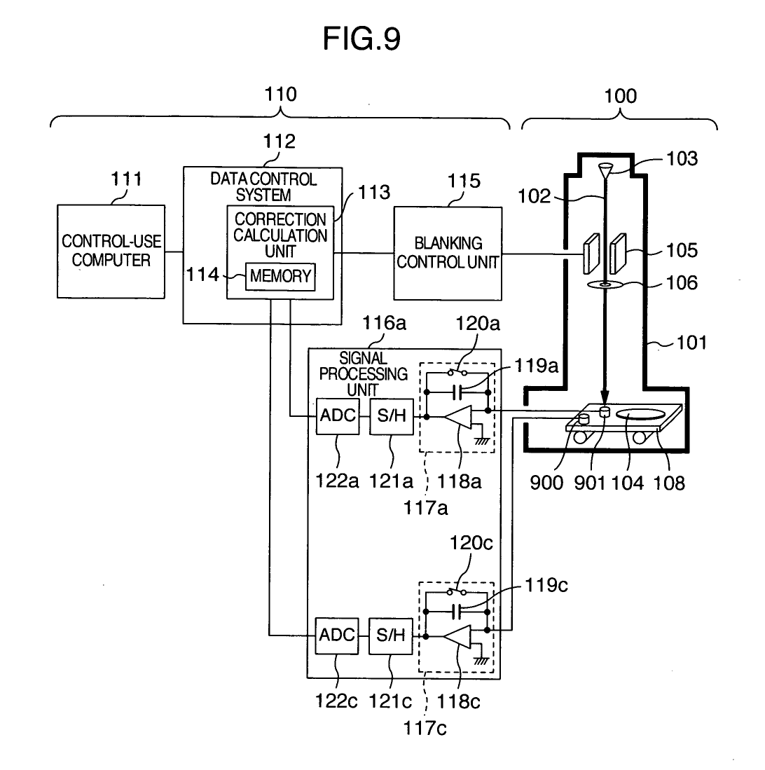

FIG. 9 illustrates an even further embodiment of the present invention. This diagram is the same as FIG. 1 except for a signal processing system 116a, a Faraday cup 900, and a photodiode 901. Consequently, as regards the same configuration components, the explanation will be omitted.

If the beam current is feeble, enhancing measurement accuracy of the measurement value requires that the signal-to-noise ratio of a signal inputted into the signal processing system 116a be enhanced. Although there can be considered a method of reducing the noise by providing a detection circuit within the column 101, it is difficult to deal with electronic-circuit components within the vacuum. Accordingly, an effective method is as follows: As the electron-beam detection member 107, a member which is equipped with amplification function is used so as to amplify the signal, thereby improving the signal-to-noise ratio of the signal inputted into the signal processing system 116a.

Appliances usable as the electron-beam detection member are such as photodiode, avalanche photodiode, combination of scintillator and photomultiplier tube, electron multiplier tube, and micro channel plate. In the present embodiment, the photodiode 901 has been used.

In general, the photodiode 901 is used as a unit for detecting light. Accordingly, it can be considered that the gain of the photodiode 901 with respect to the electron beam (i.e., the ratio of its output current relative to the entering beam current) changes depending on characteristics of the device or energy of the electron beam. Determining the gain of the photodiode relative to the electron beam requires that the beam current of the electron beam 102 which is entering the photodiode 901 be measured. For this purpose, in addition to a circuit for measuring the beam current with the use of the photodiode 901, there is provided a circuit for measuring the beam current with the use of the Faraday cup 900.

First, the electron beam 102 is irradiated onto the Faraday cup 900 in an arbitrary time. Then, the measurement is performed in accordance with the operation flowchart illustrated in FIG. 4, thereby determining the beam current. Incidentally, the details of the operation flowchart in FIG. 4 are exactly the ones described earlier.

Next, using the stage 108, the photodiode 901 is displaced to a position at which the electron beam 102 is capable of being irradiated onto the photodiode 901. Then, the measurement is performed in basically the same way. It can be considered that the measurement value with the use of the Faraday cup 900 is equivalent to the electron beam 102 entering the photodiode 901. Consequently, it becomes possible to calculate the gain of the photodiode 901 by dividing the value measured using the photodiode 901 by the value measured using the Faraday cup 900.

The use of the configuration like this makes it possible to determine the gains of the appliances such as the photodiode relative to the electron beam. This allows implementation of the beam-current measurement. In the present embodiment, the case of using the integration circuit has been indicated. In substitution therefor, it is also allowable to determine the gain by measuring the beam current by steadily irradiating the electron beam with the use of a current-voltage conversion circuit.

### Embodiment 3

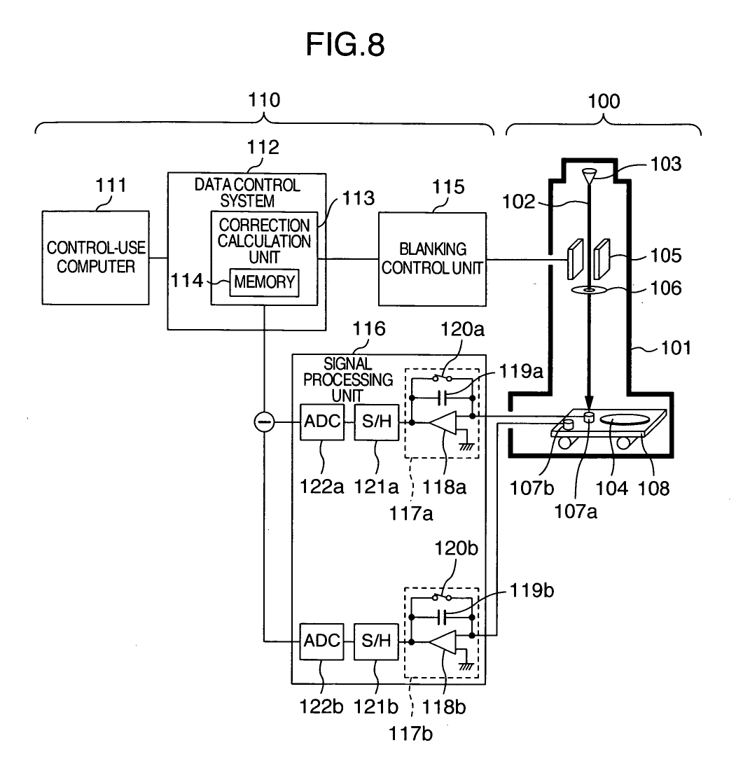

FIG. 8 illustrates still another embodiment of the present invention. This diagram is the same as FIG. 9 except for electron-beam detection members 107a and 107b. Consequently, as regards the same configuration components, the explanation will be omitted.

In the previously-described (Embodiment 1), the following scheme had been used: Namely, at the step 502 in FIG. 5, the offset value is measured in advance. After that, at the step 507, the offset value is subtracted in the software way from the results acquired by measuring the pulse beam current. The point in which the embodiment illustrated in FIG. 8 differs therefrom is that the offset value is subtracted in a hardware way.

Here, there are provided the following two sets of configuration components: The electron-beam detection members 107a and 107b, the integration circuits 117, the sample/hold circuits 121, and the A/D converters 122. One electron-beam detection member 107b is surrounded by a metallic fence, or is set at a position at which the electron beam will not enter the member 107b. Meanwhile, the electron beam is caused to enter the other electron-beam detection member 107a. Then, beam-current measurements are performed. Next, the values acquired by the measurements in the two sets of measurement systems are subtracted from each other in a hardware way by using a subtraction circuit or the like. Moreover, the value acquired by this subtraction is memorized into the memory 114 within the correction calculation unit. At this time, proofreading of the two sets of measurement systems is performed in advance, since there exists a necessity for harmonizing characteristics of the measurement systems themselves.

### Embodiment 4

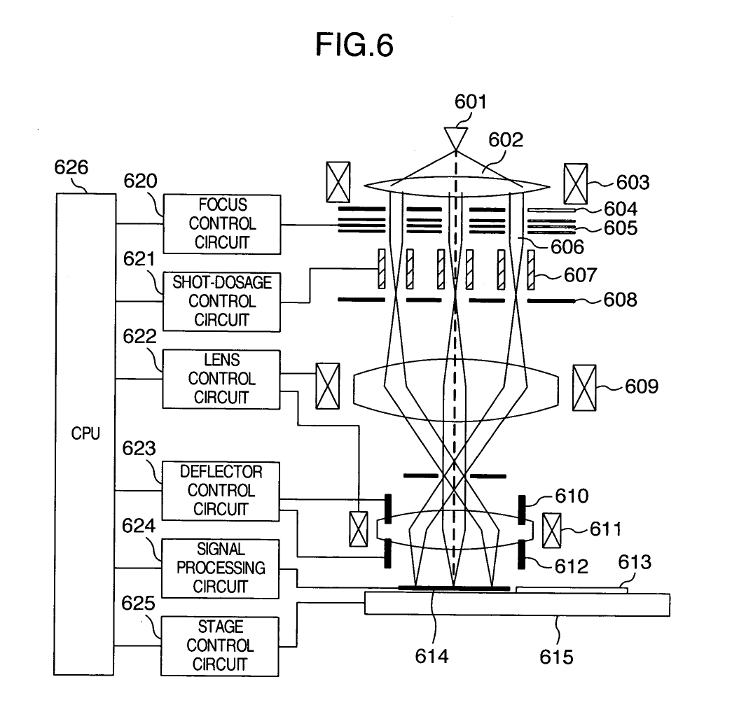

Next, referring to FIG. 6, the explanation will be given below concerning an embodiment which results from applying the present invention to a multi-electron-beam lithography system. From an electron beam 602 emitted from an electron gun 601, a plurality of electron beams 606 are formed by a condenser lens 603, an aperture array 604, and a lens array 605. These plurality of electron beams 606 are switched ON/OFF independently of each other by a blanking-electrode array 607 and a blanking-aperture array 608. Then, the electron beams 606 are projected on a sample 613 by a first projection lens 609 and a second projection lens 611. At this time, positions of the plurality of electron beams 606 on the sample 613 are scanned at the same time using a main-deflector 610 and a sub-deflector 612. A pattern drawing is performed over the entire surface of the sample by synchronizing the scanning with the ON/OFF of the plurality of electron beams 606, and displacing the sample 613 by using a sample stage 615.

A focus control circuit 620, a shot-dosage control circuit 621, a lens control circuit 622, a deflector control circuit 623, and a stage control circuit 625 control the lens array 605, the blanking-electrode array 607, the first projection lens 609 and the second projection lens 611, the main-deflector 610 and the sub-deflector 612, and the ample stage 615, respectively. A signal processing circuit 624 detects a signal from an electron-beam detection member 614, thereby performing the signal processing. A unit for performing integrated management of all the units is a CPU 626.

Here, the shot-dosage control circuit 621 includes a correction calculation unit for creating the correction data for the beam ON time and performing the correction calculation. This configuration is the same as that of the correction calculation unit 113 in FIG. 1. Also, the signal processing circuit 624 includes an integration circuit, a sample/hold circuit, and an A/D converter. This configuration is the same as that of the integration circuit 117, the sample/hold circuit 121, and the A/D converter 122 in FIG. 1.

In the multi-electron-beam lithography system, there are some cases where the characteristics of each electron beam differ on each electron-beam basis due to causes such as nonuniformity in radiation current-density distribution from the electron gun 601 and mechanical errors in the configuration components configuring the electron optical system. As a result of this, the beam shot dosage becomes different for each electron beam. Accordingly, even if one and the same beam ON time is set thereto, the dimension of a drawing pattern does not become uniform. On account of this, prior to the pattern drawing and for all of the plurality of electron beams 606, the beam shot dosages during an arbitrary beam ON time are measured in accordance with the operation flowcharts illustrated in FIG. 4 and FIG. 5. Moreover, from the measurement results, the correction data for the beam ON time is determined. At the time of an actual pattern drawing, the correction calculation is performed based on the correction data for the beam ON time. This has allowed acquisition of the optimum beam shot dosage for each electron beam, thereby making it possible to form the high-dimension-accuracy drawing pattern.

### Embodiment 5

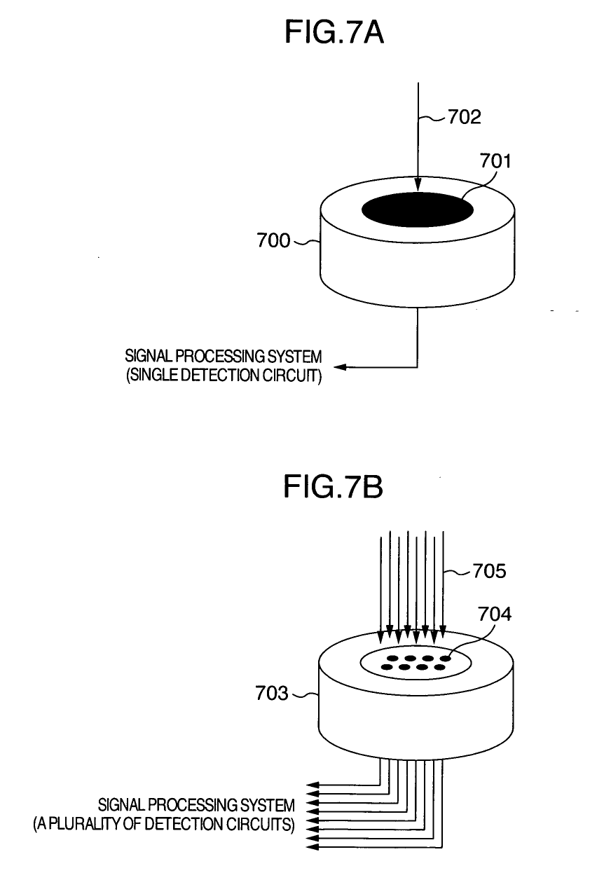

Next, referring to FIG. 7A and FIG. 7B, the explanation will be given below regarding embodiments of the electron-beam detection member 614 of the multi-electron-beam lithography system illustrated in FIG. 6. FIG. 7A illustrates an embodiment where a photodiode 700 having a single light-receiving surface 701 is used as the electron-beam detection member. In this case, of a plurality of electron beams, only a single electron beam 702 is selected and irradiated, thereby performing the measurement. After that, the selection and the irradiation are performed with respect to the other electron beams as well, thereby repeating basically the same measurements.

FIG. 7B illustrates an embodiment where a photodiode 703 having a plurality of light-receiving surfaces 704 is used. By using the arrayed photodiode 703 having the plurality of light-receiving surfaces 704 and a plurality of detection circuits located at the backward stage thereof, it becomes possible to execute the beam-current measurements with respect to a plurality of electron beams 705 at one time. This allows implementation of shortening of the measurement time.

### Embodiment 6

In the multi-electron-beam lithography system illustrated in FIG. 6, there are some cases where the characteristics of each electron beam tremendously differ from each other. On account of this, a certain amount of threshold value is set to the beam ON time after being measured and corrected. Then, if the beam ON time has exceeded the threshold value, the CPU 626 is notified of the abnormality. The CPU 626 displays a warning message on a display screen, then halting the system. Otherwise, the following method is allowable: If there exist only a small number of beams which have exceeded the threshold value, the drawing is performed without using these beams. After that, using the other beams, the drawing is performed over areas of which these beams are in charge.

As having been explained so far, according to the embodiments of the present invention, the correction data for the beam ON time is created in advance. After that, the correction calculation is performed based on the correction data created. This makes it possible to prevent a lack or excess of the beam shot dosage caused by factors such as delay in the rising of the blanking voltage, defocus of the beam, beam shape, and deviation of the beam axis. When applying these embodiments to, e.g., the fabrication process of semiconductor integrated circuits, it becomes possible to fabricate high-dimension-accuracy semiconductor integrated circuits.

According to these embodiments, it becomes possible to provide the electron-beam lithography method and electron-beam lithography system which allow formation of a high-dimension-accuracy drawing pattern on a sample.

The present invention includes the following configurations:

(1)

An electron-beam lithography method for performing electron-beam lithography by irradiating a plurality of electron beams on a sample, the method including the steps of:
detecting the plurality of electron beams generated by an electron-beam generation member,
integrating a detection output which an electron-beam detection member detects,
creating electron-beam shot dosage data based on an integration value acquired by the integration,
determining the electron-beam shot dosage or electron-beam ON time on each electron-beam basis, and
switching the plurality of electron beams ON/OFF individually by a blanking member at time-interval of the determined electron-beam ON time.
   (2)

An electron-beam lithography system for performing electron-beam lithography by irradiating a plurality of electron beams on a sample, the system including:
an electron-beam generation member for generating the plurality of electron beams,
an electron-beam detection member for detecting the plurality of electron beams,
a blanking member for switching the plurality of electron beams ON/OFF individually,
a lens for converging the plurality of electron beams on a sample,
a deflector for determining positions of the plurality of electron beams on the sample,
a stage for mounting the sample thereon thereby to displace the sample,
a control-use computer for controlling the electron-beam detection member, the blanking member, the lens, the deflector, and the stage,
an integration member for integrating an output current from the electron-beam detection member,
a memory member for memorizing an integration value acquired by the integration,
a data creation member for creating electron-beam shot dosage data based on the integration value memorized into the memory member, and
a correction calculation member for performing correction calculation of the electron-beam shot dosage or electron-beam shot time based on the electron-beam shot dosage data.
   (3)

An electron-beam lithography system for performing electron-beam lithography by irradiating an electron beam on a sample, the system including:
an electron-beam generation member for generating the electron beam,
at least two or more different electron-beam detection members having a function of detecting the electron beam, and
a proofreading member for selecting, as a reference value, a measurement value detected by at least one electron-beam detection member out of the electron-beam detection members, and for performing proofreading of a measurement value detected by the other electron-beam detection member.
   (4)

The electron-beam lithography system described in 3, wherein at least the one electron-beam detection member is equipped with a function of amplifying a detection signal.

(5)

The electron-beam lithography system described in 3, wherein at least the one electron-beam detection member is equipped with a function of integrating a detection output thereby to determine an integration value.

It should be further understood by those skilled in the art that although the foregoing description has been made on embodiments of the invention, the invention is not limited thereto and various changes and modifications may be made without departing from the spirit of the invention and the scope of the appended claims.

1. An electron-beam lithography method for performing electron-beam lithography by irradiating an electron beam on a sample, said method comprising the steps of:
detecting said electron beam generated by electron-beam generation means,
integrating a detection output which electron-beam detection means detects,
creating electron-beam shot dosage data based on an integration value acquired by said integration,
determining said electron-beam shot dosage or electron-beam ON time, and
switching said electron beam ON/OFF by blanking means at time-interval of said determined electron-beam ON time.

2. An electron-beam lithography system for performing electron-beam lithography by irradiating an electron beam on a sample, said system comprising:
electron-beam generation means for generating said electron beam,
electron-beam detection means for detecting said electron beam,
blanking means for switching said electron beam ON/OFF,
a lens for converging said electron beam on a sample,
a deflector for determining position of said electron beam on said sample,
a stage for mounting said sample thereon thereby to displace said sample,
a control-use computer for controlling said electron-beam detection means, said blanking means, said lens, said deflector, and said stage,
integration means for integrating an output current from said electron-beam detection means,
memory means for memorizing an integration value acquired by said integration,
data creation means for creating electron-beam shot dosage data based on said integration value memorized into said memory means, and
correction calculation means for performing correction calculation of said electron-beam shot dosage or electron-beam shot time based on said electron-beam shot dosage data.

3. An electron-beam current measurement method for measuring electron-beam current by using means for detecting an electron beam, wherein
there are provided at least two or more different electron-beam detection means, and
said method comprising the steps of:
selecting, as a reference value, a measurement value detected by at least one electron-beam detection means, and
performing proofreading of a measurement value detected by the other electron-beam detection means.

4. The electron-beam current measurement method according to claim 3, wherein at least said one electron-beam detection means is equipped with a function of amplifying a detection signal.

5. The electron-beam current measurement method according to claim 3, wherein said electron-beam detection means for detecting said reference value is configured to detect said reference value by using a Faraday cup.

6. The electron-beam current measurement method according to claim 3, wherein at least said one electron-beam detection means is equipped with a function of integrating a detection output thereby to determine an integration value.
